(19) United States
(12) Patent Application Publication
(10) Pub. No.: US 2023/0403174 A1
(43) Pub. Date: Dec. 14, 2023

(54) INTELLIGENT VIRTUAL EVENT ASSISTANT

(71) Applicant: Dell Products L.P., Round Rock, TX (US)

(72) Inventors: Bijan Kumar Mohanty, Austin, TX (US); Gregory Michael Ramsey, Seattle, WA (US); Hung Dinh, Austin, TX (US)

(73) Assignee: Dell Products L.P., Round Rock, TX (US)

(21) Appl. No.: 17/806,137

(22) Filed: Jun. 9, 2022

(51) Int. Cl. H04L 12/18; H04L 51/02

(52) U.S. Cl. CPC H04L 12/1831; H04L 12/1818; H04L 12/1822; H04L 51/02

(57) ABSTRACT

In one aspect, an example methodology implementing the disclosed techniques includes, by a virtual event assistant, joining an online meeting and receiving a content of the online meeting in real-time, the content including an audio stream and a video stream of the online meeting. The method also includes, by the virtual event assistant, generating a summarized content of the online meeting based on a transcript of the online meeting, wherein generating the summarized content includes applying one or more artificial intelligence (AI)-based techniques to the transcript of the online meeting. The method further includes, by the virtual meeting assistant, determining contextual metadata of the online meeting based on analysis of the content of the online meeting. The method may also include providing the summarized content with the contextual metadata of the online meeting for playback by a user, for example.

### BACKGROUND

Organizations schedule meetings for a variety of reasons. For example, within a company, employees may participate in (e.g., attend) monthly planning meetings, weekly status meetings, meetings with vendors, sales meetings with customers, etc. Online or “virtual” meetings are an increasingly popular way for people to collaborate, particularly when they are in different physical locations. Online meeting services, such as TEAMS, SKYPE, ZOOM, GOTOMEETING, and WEBEX, may provide audio and video conferencing among other features. Using such services, a user may use an online meeting application installed on their client device and participate in an online meeting or “conference” with other participants in different physical locations.

### SUMMARY

This Summary is provided to introduce a selection of concepts in simplified form that are further described below in the Detailed Description. This Summary is not intended to identify key or essential features or combinations of the claimed subject matter, nor is it intended to be used to limit the scope of the claimed subject matter.

In accordance with one illustrative embodiment provided to illustrate the broader concepts, systems, and techniques described herein, a method includes, by a virtual event assistant, joining an online meeting and receiving a content of the online meeting in real-time, the content including an audio stream and a video stream of the online meeting. The method also includes, by the virtual event assistant, generating a summarized content of the online meeting based on a transcript of the online meeting, wherein generating the summarized content includes applying one or more artificial intelligence (AI)-based techniques to the transcript of the online meeting, and determining contextual metadata of the online meeting based on analysis of the content of the online meeting. The method may further include providing the summarized content with the contextual metadata of the online meeting for playback by a user.

In some embodiments, generating the summarized content includes applying a domain-specific language model to the transcript of the online meeting.

In one aspect, the domain-specific language model is tuned to a domain-specific vocabulary representing language used within an organization.

In some embodiments, the analysis of the content of the online meeting includes using AI and machine learning (ML)-based techniques.

In some embodiments, the contextual metadata includes information indicative of participants who participated in the online meeting.

In some embodiments, the contextual metadata includes information indicative of active participants in the online meeting.

In some embodiments, the contextual metadata includes information indicative of a topic of the online meeting.

In some embodiments, the contextual metadata includes information indicative of an intent of the online meeting.

In some embodiments, the contextual metadata includes information indicative of a sentiment associated with a participant in the online meeting.

In some embodiments, the contextual metadata includes one or more images shared during the online meeting.

In some embodiments, the contextual metadata includes a summary of one or more images shared during the online meeting.

In some embodiments, the contextual metadata includes information indicative of a question raised and answered during the online meeting.

According to another illustrative embodiment provided to illustrate the broader concepts described herein, a system includes one or more non-transitory machine-readable mediums configured to store instructions and one or more processors configured to execute the instructions stored on the one or more non-transitory machine-readable mediums. Execution of the instructions causes the one or more processors to carry out a process corresponding to the aforementioned method or any described embodiment thereof.

According to another illustrative embodiment provided to illustrate the broader concepts described herein, a non-transitory machine-readable medium encodes instructions that when executed by one or more processors cause a process to be carried out, the process corresponding to the aforementioned method or any described embodiment thereof.

### BRIEF DESCRIPTION OF THE DRAWINGS

The foregoing and other objects, features and advantages will be apparent from the following more particular description of the embodiments, as illustrated in the accompanying drawings in which like reference characters refer to the same parts throughout the different views. The drawings are not necessarily to scale, emphasis instead being placed upon illustrating the principles of the embodiments.

FIG. 1 is a diagram of an illustrative network environment in which a virtual event assistant can be used to conduct an online meeting, in accordance with an embodiment of the present disclosure.

FIG. 2 is a block diagram of an illustrative online meeting assistant service, in accordance with an embodiment of the present disclosure.

FIG. 3 is a flow diagram of an example process for providing summarized content with contextual metadata of an online meeting, in accordance with an embodiment of the present disclosure.

FIG. 4 is a block diagram illustrating selective components of an example computing device in which various aspects of the disclosure may be implemented, in accordance with an embodiment of the present disclosure.

### DETAILED DESCRIPTION

With the increase in work-from-home, hybrid, and other flexible working arrangements, it is common for employees to participate in online meetings from their homes or even from cafes or other public spaces. This can result in an employee being invited to and/or required to attend many online meetings, some of which may be scheduled for the same time (e.g., conflict). Thus, the employee may not have time to attend certain meetings and miss out on the useful information discussed during these meetings. Even in cases where the employee attends a meeting, he or she may be distracted during the meeting due to other persons near or within the same physical environment as the employee. Some online meeting services may provide a feature to automatically generate a recording of a meeting, which can be played back offline (e.g., after the meeting). However, since useful information may be discussed at different points during the meeting, a person who missed the meeting will have to playback (e.g., review) the entire recording to perceive or gather the useful information as well as the context of the discussion during the meeting. Unfortunately, this can be inefficient in terms of computing resources and user productivity (e.g., meeting participant may be distracted while attending an online meeting and, thus, still need to review the recording) and such inefficiencies may be compounded when reviewing multiple meeting recordings.

Certain embodiments of the concepts, techniques, and structures disclosed herein are directed to an artificial intelligence (AI)/machine learning (ML)-powered framework for providing summarized content with contextual metadata of online (or “virtual”) meetings. In some embodiments, an online meeting assistant service provides a selectable virtual event assistant feature which can be enabled for online meetings (sometimes referred to herein more simply as “meetings” or a “meeting” in the singular). When enabled for an online meeting, a virtual event assistant joins and participates in (e.g., attends) the online meeting as a client. Once connected to the online meeting, the virtual event assistant may receive the content (e.g., audio stream and video stream) of the online meeting provided to the attendees of the online meeting. The virtual meeting assistant may use AI/ML-based techniques to process the content of the online meeting to generate summarized content with contextual metadata. The metadata-enriched summarized content of the online meeting allows for efficient and comprehensive review of the salient information of the meeting in a concise manner by users, such as, for example, attendees of the online meeting and/or others who could not attend the online meeting.

In some embodiments, the virtual event assistant can receive the content (e.g., audio and video streams) of a meeting in real-time and record the content, e.g., the audio stream and/or video stream, of the meeting. For example, the content may be stored and appropriately identified on a non-volatile computer-readable medium (i.e., non-volatile memory). In one embodiment, the virtual event assistant can store the audio and/or video associated with the audio and/or video streams of the meeting. For example, the virtual assistant can store the audio and/or the video data from the audio and/or video streams of the meeting (e.g., audio data and/or video data extracted from the audio stream and/or video stream).

In some embodiments, the virtual event assistant can generate a transcript of the meeting. For example, the virtual event assistant may process the audio stream of the meeting using Automatic Speech Recognition (ASR) and/or Natural Language Understanding (NLU) techniques to generate a transcript (e.g., text data) of the meeting (e.g., text strings representing the conversation which occurred during the meeting). In one embodiment, the virtual event assistant may generate the transcript of the meeting in real-time (i.e., concurrent with the meeting). In other embodiments, the virtual event assistant may generate the transcript of the meeting at a later time (e.g., after conclusion of the meeting). In either case, the virtual event assistant can store the transcript of the meeting for subsequent consumption, analysis, processing, etc., for example.

In some embodiments, the virtual meeting assistant can generate a summarized content of the meeting based on the transcript of the meeting. The summarized content provides a summary of the meeting which accurately conveys the context and/or intent/topic of the meeting. For example, the virtual event assistant may analyze the transcript of the meeting using Natural Language Processing (NLP) techniques to generate a summarized content of the meeting which maintains the context/intent/topic of the meeting. In one embodiment, one or more domain-specific language models may be applied to the transcript to generate the summarized content of the meeting. A domain-specific language model may be tuned to a domain-specific vocabulary which represents the language that is used primarily within an area of knowledge or a group, such as within a specific organization (e.g., a company), a specific group of persons, etc.

In some embodiments, the virtual meeting assistant can provide metadata (e.g., contextual metadata) with the summarized content of the meeting to enable efficient and comprehensive review of the content of the meeting. Metadata can be any data that describes or provides information about the meeting other than the content of the meeting, e.g., the audio and video stream of the meeting. For example, the virtual meeting assistant may analyze the content of the online meeting (e.g., transcription, audio data/stream, and/or video data/stream) using AI and ML-based techniques to determine the metadata. Non-limiting examples of the types of contextual metadata include participants who participated in the meeting, active participants, topic of the meeting, intent(s), sentiment(s), questions raised and answered, images shared during the meeting (e.g., presentation slides, shared content, etc.), and summaries of the shared images, to provide several examples.

In some embodiments, the virtual meeting assistant can provide a translation of the summarized content of the meeting from a first language to a second language. For example, the virtual meeting assistant my use an NLP-based translator to translate the summarized content from the first language to the second language. The first language may be the language of the conversation which occurred during the meeting. The second language may be a language different than the first language. The second language may be specified by a user (e.g., a participant of the meeting).

In some embodiments, the virtual meeting assistant can covert the text content of the meeting to speech (e.g., audio content). In one embodiment, the text content may be a summarized text content of the meeting. In some embodiments, the virtual meeting assistant can convert the speech content of the meeting to text content. In one embodiment, the speech content may be a summarized speech content of the meeting. For example, the virtual meeting assistant may leverage AI/computer vision-based technologies (e.g., image processing and optical character recognition (OCR)) to convert the text content to speech, and vice versa. In one embodiment, the virtual meeting assistant can provide a selectable option to playback (e.g., audio playback or read-aloud) the summarized meeting content for passive consumption, such as while performing another activity (e.g., driving).

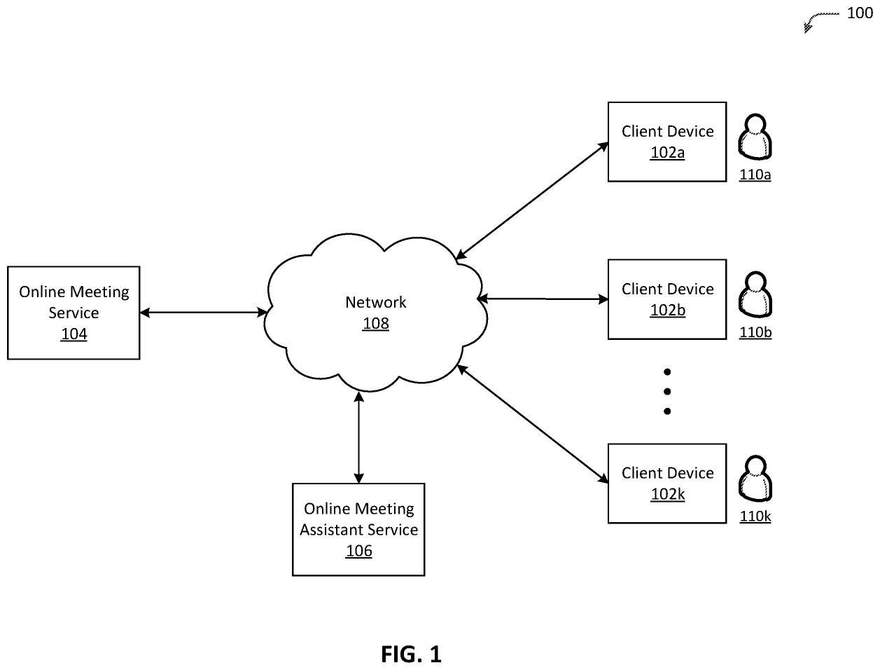

FIG. 1 is a diagram of an illustrative network environment 100 in which a virtual event assistant can be used to conduct an online meeting, in accordance with an embodiment of the present disclosure. As shown, illustrative network environment 100 includes client devices 102a, 102b, . . . , 102k (102 generally), an online meeting service (or “meeting service”) 104, and an online meeting assistant service. 106 Client devices 102, online meeting service 104, and online meeting assistant service 106 may be communicably coupled to one another via a network 108.

Network 108 may correspond to one or more wireless or wired computer networks including, but not limited to, local-area networks (LANs), metropolitan area networks (MANs), wide area networks (WANs), wireless local-area networks (WLAN), primary public networks, primary private networks, cellular networks, Wi-Fi (i.e., 802.11) networks, Bluetooth networks, and Near Field Communication (NFC) networks. In some embodiments, network 108 may include another network or a portion or portions of other networks. Online meeting service 104 and/or online meeting assistant service 106 may be provided as part of a cloud computing environment.

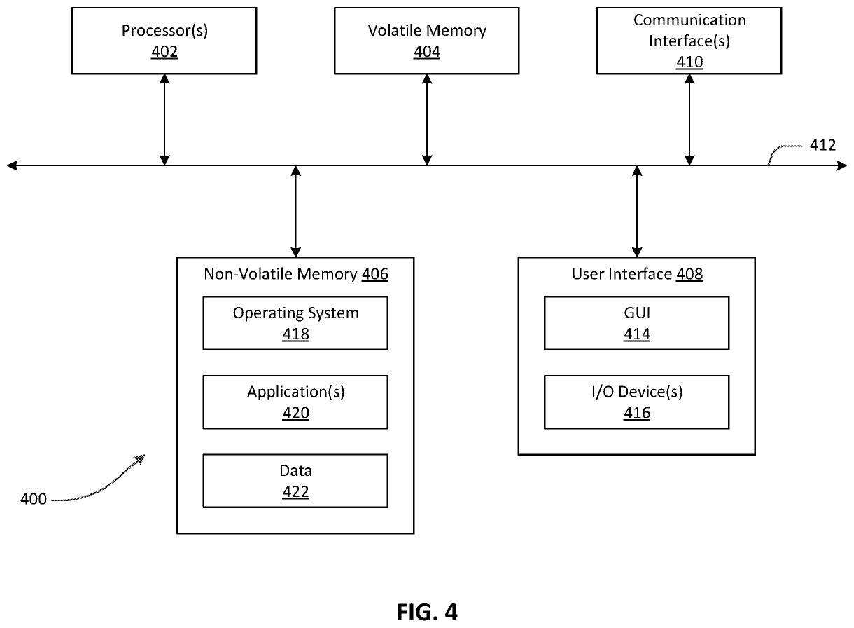

Network environment 100 may provide services for one or more organizations, with the organizations having one or more users associated with it. A given client device (e.g., client device 102) may be assigned to or otherwise associated with a particular user. For example, as shown in FIG. 4, client devices 102a, 102b, . . . , 102k may be used by or otherwise associated with users 110a, 110b, . . . , 110k (110 generally), respectively. Client devices 102 can include, for example, desktop computing devices, laptop computing devices, tablet computing devices, and/or mobile computing devices. Client devices 102 can be configured to run one or more applications, such as desktop applications, mobile applications, and SaaS applications. Among various other types of applications, client devices 102 can run a meeting application that provides audio and video conferencing among other features. For example, client devices 102 can run TEAMS, SKYPE, ZOOM, GOTOMEETING, WEBEX, or another meeting application. The meeting application running on client devices 102 can communicate with meeting service 104 and/or with the meeting applications running on other client devices 102 (e.g., using peer-to-peer communication). An example of a client device that may be the same as or similar to any of client devices 102 is described below with respect to FIG. 4.

Meeting service 104 may correspond to any service that provides collaboration and communication functionality to enable online meetings to occur between meeting attendees at various locations. For example, meeting service 104 may correspond to an online meeting and/or conferencing service such as TEAMS, SKYPE, ZOOM, GOTOMEETING, WEBEX, etc. In some embodiments, meeting service 104 may correspond to a SaaS application running in the cloud. In some embodiments, meeting service 104 may be omitted and meeting/conferencing applications running on client devices 102 may directly communicate with each other using P2P communication.

Online meeting assistant service 106 is configured to provide a selectable virtual event assistant feature which can be enabled for online meetings. In one embodiment, a user interface (UI) element which can be used to selectively enable the virtual event assistant feature may be provided on client device 102 used to participate in (or “attend”) an online meeting. For example, a meeting application or a different client application on client device 102 can provide a UI element, such as a toggle switch, a button, a checkbox, or other type of control, for selectively enabling the virtual event assistant feature for an online meeting. A user of client device 102 may click/tap on the UI element to enable the virtual event assistant feature for an online meeting. In some embodiments, online meeting assistant service 106 may be provided as a service (e.g., a microservice) within a cloud computing environment.

In the example of FIG. 1, users 110 may use respective meeting applications on client devices 102 to join and participate in an online meeting hosted by meeting service 104. During the meeting, a meeting attendee (e.g., user 110) may click/tap a UI element provided on a UI of the meeting application to enable the virtual event assistant feature for the online meeting. In response to the meeting attendee clicking/tapping such UI element, online meeting assistant service 106 can initiate a virtual event assistant for the online meeting. The virtual assistant can then join the online meeting as a participant and generate a summarized content with contextual metadata of the online meeting.

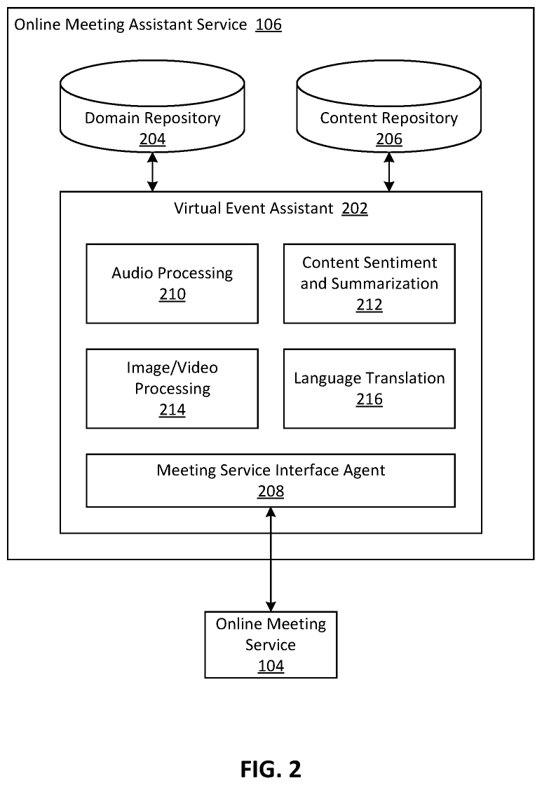

In some embodiments, the virtual event assistant feature may be scheduled to be initiated. For example, a user invited to an online meeting may schedule the virtual event assistant feature by sending a meeting invite to online meeting assistant service 106 via a calendaring application, such as MICROSOFT OUTLOOK or any other application capable of sending meeting invites. Then, at the scheduled time, online meeting assistant service 106 can initiate a virtual event assistant for the online meeting based on the meeting details (e.g., meeting link, meeting id, password, etc.) in the meeting invite. Further description of the virtual event assistant and other processing that can be implemented within online meeting assistant service 106 is provided below at least with respect to FIG. 2.

FIG. 2 is a block diagram of illustrative online meeting assistant service 106 of FIG. 1, in accordance with an embodiment of the present disclosure. In FIG. 2, like elements of FIG. 1 are shown using like reference designators and, unless context dictates otherwise, may not be described again for purposes of clarity. An organization such as a company, an enterprise, or other entity, may implement and use the framework of online meeting service 106 to provide summarized content with contextual metadata of online meetings. Online meeting assistant service 106 may be implemented as computer instructions executable to perform the corresponding functions disclosed herein. Online meeting assistant service 106 can be logically and/or physically organized into one or more components. The various components of proactive customer support service 110 can communicate or otherwise interact utilizing application program interfaces (APIs), such as, for example, a Representational State Transfer (RESTful) API, a Hypertext Transfer Protocol (HTTP) API, or another suitable API, including combinations thereof.

In the example of FIG. 2, online meeting assistant service 106 includes a virtual event assistant 202, a domain repository 204, and a content repository 206. Online meeting assistant service 106 can include various other components (e.g., software and/or hardware components) which, for the sake of clarity, are not shown in FIG. 2. It is also appreciated that online meeting assistant service 106 may not include certain of the components depicted in FIG. 2. For example, in certain embodiments, online meeting assistant service 106 may not include one or more of the components illustrated in FIG. 2, but online meeting assistant service 106 may connect or otherwise couple to the one or more components via a communication interface. Thus, it should be appreciated that numerous configurations of online meeting assistant service 106 can be implemented and the present disclosure is not intended to be limited to any particular one. That is, the degree of integration and distribution of the functional component(s) provided herein can vary greatly from one embodiment to the next, as will be appreciated in light of this disclosure.

Referring to online meeting assistant service 106, in one implementation, virtual event assistant 202 may be configured to service a single online meeting. For example, in response to enablement of the virtual event assistant feature for an online meeting, online meeting assistant service 106 can initiate an instance of virtual event assistant 202 to provide the virtual assistant functionality for that online meeting. In other words, an instance of virtual event assistant 202 is initiated to service each request for a virtual event assistant (e.g., each enablement of the virtual event assistant feature for an online meeting). In other implementations, virtual event assistant 202 may be configured to service multiple online meetings. In other words, virtual event assistant 202 can provide the virtual assistant functionality for one or more online meetings. In the example of FIG. 5, virtual event assistant 202 includes a meeting service interface agent 208, an audio processing module 210, a content sentiment and summarization module 212, an image/video processing module 214, and a language translation module 216.

Referring to virtual event assistant 202, upon initiation for a given online meeting hosted by online meeting service 104, meeting service interface agent 208 can join and participate in the online meeting. As a participant in the online meeting, meeting service interface agent 208 can receive the content of the online meeting in real-time. The content of the online meeting can include the audio stream and video stream of the online meeting. For example, the audio stream and video stream of the online meeting may be received from online meeting service 104 which is hosting the online meeting. In some embodiments, meeting service interface agent 208 can store the content of the online meeting within content repository 206. The online meeting content stored within content repository 206 can be appropriately identified for later retrieval and use (e.g., processing by various components of virtual event assistant 202 as described herein). Content repository 206 may correspond to, for example, a storage service within the computing environment of online meeting assistant service 106.

Audio processing module 210 is operable to generate a transcript of the online meeting. For example, audio processing module 210 can retrieve the stored audio stream of the online meeting from content repository 206 and process the audio stream to generate a transcription. In some embodiments, audio processing module 210 may use voice activity detection (VAD) or other suitable speech recognition technique to determine the speech and non-speech segments of the audio stream. Audio processing module 210 can then process the speech segments of the audio stream using automatic speech recognition, natural language understand (NLU), and/or other suitable speech recognition technique to generate a transcript of the online meeting (e.g., transcribe the speech segments of the audio stream into text strings). The generated transcript (e.g., text data) represents the conversation which occurred during the online meeting.

In some embodiments, audio processing module 210 may timestamp the speech segments and the non-speech segments of the audio stream to identify when the individual speech segments occurred. In some embodiments, audio processing module 210 can store the transcript of the online meeting within content repository 206. The transcript of the online meeting stored within content repository 206 can be appropriately identified for later retrieval and use. For example, audio processing module 210 may include timestamps in the transcript which correspond to the timestamps of the speech segments in the audio stream. The generated timestamps can then be used to identify specific speech segments within the audio stream and/or specific text strings in the transcription.

In some embodiments, audio processing module 210 may generate the transcript in real-time (e.g., concurrent with the online meeting). In other embodiments, audio processing module 210 may generate the transcript after conclusion of the online meeting.

Content sentiment and summarization module 212 is operable to generate a summarized content of the online meeting based on the transcript of the online meeting. The summarized content provides a summary of the online meeting which accurately conveys the context and/or intent/topic of the meeting. As language is domain specific, in some embodiments, content sentiment and summarization module 212 may leverage a domain-specific language model to generate the summarized content. The domain-specific language model can be tuned (or “customized”) to a domain-specific vocabulary (i.e., trained using a domain-specific vocabulary). The domain-specific vocabulary may represent the language that is used primarily within an area of knowledge or a group. For example, the word “genesis” may have a specific meaning within an organization which may be different or not understood by those outside of the organization. A domain-specific language model that is tuned to a domain-specific vocabulary allows for recognition of the vocabulary words that are specific to the domain (e.g., a specific organization). This in turn allows for recognizing the context of the meeting (e.g., the context of the conversation which occurred during the meeting).

To generate a summarized content, content sentiment and summarization module 212 can retrieve the stored transcript of the online meeting from content repository 206 and a domain-specific language model that is tuned to a domain-specific vocabulary from domain repository 204, which may correspond to, for example, a storage service within the computing environment of online meeting assistant service 106. Content sentiment and summarization module 212 can then generate the summarized content by applying the domain-specific language model to the transcript of the online meeting. The generated content summary is based on the words included in the domain-specific vocabulary and, thus, conveys the context and/or intent/topic of the meeting as represented by the domain-specific vocabulary. In some embodiments, the domain-specific vocabulary used to tune the domain-specific language model may be configurable by the organization and/or the user (e.g., a participant of the online meeting). The domain-specific vocabulary or vocabularies can be stored within domain repository 204. In some embodiments, content sentiment and summarization module 212 can store the summarized content of the online meeting within content repository 206, where it can subsequently be retrieved and provided to attendees of the online meeting and/or others who could not attend the online meeting, for example.

In some embodiments, online meeting from content repository 206 may convert the content summary (i.e., the text of the content summary) to speech (e.g., audio format) using a suitable text to speech application. In brief, a text to speech application converts written text into spoken words. In some embodiments, online meeting from content repository 206 can store the audio file(s) containing the speech within content repository 206, where it can subsequently be retrieved and utilized.

In some embodiments, content sentiment and summarization module 212 is operable to determine contextual metadata of the online meeting. The contextual metadata allows for comprehensive and enhanced review and understanding of the summarized content of the online meeting. Non-limiting examples of the types of contextual metadata include participants who participated in the meeting, active participants, topic of the meeting, intent(s), sentiment(s), questions raised and answered, images shared during the meeting (e.g., presentation slides, shared content, etc.), and summaries of the shared images, to provide several examples. In some embodiments, content sentiment and summarization module 212 can store the determined contextual metadata of the online meeting within content repository 206, where it can subsequently be retrieved and provided with the content summary to attendees of the online meeting and/or others who could not attend the online meeting, for example.

According to one embodiment, content sentiment and summarization module 212 may determine the participants who participated in (attended) the online meeting. For example, content sentiment and summarization module 212 may determine some or all participants from the online meeting invite. Content sentiment and summarization module 212 may also determine some or all participants in the online meeting by analyzing the audio stream and/or video stream of the online meeting using AI-based techniques such as, for example, voice recognition and image recognition. For example, the audio stream may include names of the participants (e.g., a meeting participant may have introduced him/herself during the meeting). As another example, the video stream may include images of persons from which the participant in the online meeting may be identified.

According to one embodiment, content sentiment and summarization module 212 may determine the participants who were active (i.e., active participants) during the online meeting. For example, content sentiment and summarization module 212 can retrieve the stored audio stream of the online meeting from content repository 206 and use VAD other suitable speech recognition technique to determine the speech and non-speech segments of the audio stream. Content sentiment and summarization module 212 can then apply voice fingerprints for some or all participants in the online meeting to the speech segments to attribute the speech segments to the different speakers (e.g., associate a meeting participant to the individual speech segments). Similarly, content sentiment and summarization module 212 can also attribute the text strings in the content summary to the different meeting participants. Content sentiment and summarization module 212 can determine the speakers during the online meeting to be the active participants. In cases where a voice fingerprint for a participant in the online meeting is not available, content sentiment and summarization module 212 can use a general designation, such as “Participant 1”, “Participant 2”, etc., to differentiate (e.g., distinguish) the text strings in the content summary.

According to one embodiment, content sentiment and summarization module 212 may determine a topic(s) of the online meeting. For example, content sentiment and summarization module 212 can retrieve the stored content summary of the online meeting from content repository 206. Content sentiment and summarization module 212 can then apply a topic classification model or other suitable text classification technique to the text strings in the content summary to determine the topic of the online meeting. The topic classification model utilizes ML and NLP techniques to analyze the text strings and assign a set of predefined categories based on its content. In another embodiment, content sentiment and summarization module 212 may apply the topic classification model to the transcript of the online meeting (e.g., text strings in the transcript of the online meeting). For example, content sentiment and summarization module 212 can use the transcript of the online meeting to determine the sentiment of the conversation which occurred during the meeting as well as a summarized text from the original conversation text. In some embodiments, the topic classification model may be based on the domain-specific vocabulary.

According to one embodiment, content sentiment and summarization module 212 may determine an intent(s) of the online meeting. For example, content sentiment and summarization module 212 can retrieve the stored content summary of the online meeting from content repository 206. Content sentiment and summarization module 212 can then apply an intent classification model or other suitable text classification technique to the text strings in the content summary to determine the intent of the online meeting. The intent classification model utilizes ML and NLP techniques to associate words or expressions in the text strings with a particular intent. For example, the intent classification model can learn that a certain word or words (e.g., buy, obtain, acquire) are associated with a particular intent (e.g., intent to purchase). In another embodiment, content sentiment and summarization module 212 may apply the intent classification model to the transcript of the online meeting (e.g., text strings in the transcript of the online meeting). In some embodiments, the intent classification model may be based on the domain-specific vocabulary.

According to one embodiment, content sentiment and summarization module 212 may determine a sentiment of the online meeting. The sentiment may be associated with a participant in the online meeting. Additionally or alternatively, the sentiment may be of the online meeting in general. For example, content sentiment and summarization module 212 can retrieve the stored content summary of the online meeting from content repository 206. Content sentiment and summarization module 212 can then apply a sentiment classification model or other suitable ML model to the text strings in the content summary to determine the sentiment of the individual text strings. The intent classification model utilizes ML and NLP techniques to detect sentiment (e.g., positive, negative, neutral) in a text string. In some cases, the intent classification model can be tuned (e.g., trained) to additionally or alternatively detect emotions such as happiness, frustration, anger, and sadness, in a text string. Based on the sentiment(s) detected in the text strings, content sentiment and summarization module 212 can determine a sentiment associated with a meeting participant (e.g., text strings may be attributed to the various meeting participants as described previously). Content sentiment and summarization module 212 can also determine a sentiment of the online meeting based on the determined sentiments of the participants in the online meeting. For example, if a majority of the meeting participants are determined to be positive (e.g., associated with a positive sentiment), content sentiment and summarization module 212 may determine that the sentiment of the online meeting is positive.

According to one embodiment, content sentiment and summarization module 212 may determine questions raised and answered during the online meeting. For example, content sentiment and summarization module 212 can retrieve the stored content summary of the online meeting from content repository 206. Content sentiment and summarization module 212 can then analyze the text strings using NLP-techniques to determine the presence of a question(s) in the text string. Content sentiment and summarization module 212 can also use the same or similar NLP-techniques to determine whether the text strings include answers to the question(s).

With continued reference to the different types of contextual metadata, image/video processing module 214 is operable to determine whether images of content were shared during the online meeting. For example, during the online meeting, a meeting participant may have shared presentation slides with the other meeting attendees. As another example, a meeting participant may have shared a desktop screen or an application window with the other meeting attendees. To determine whether images were shared, image/video processing module 214 can retrieve the stored video stream of the online meeting from content repository 206 and analyze the video stream using object recognition techniques to detect the presence of images of content (e.g., images of presentation slides, images of application windows, images of computing device screens, etc.) in the video stream. Upon determining the presence of an image, image/video processing module 214 can extract the image from the video stream. In some embodiments, image/video processing module 214 can store the extracted images within content repository 206, where it can subsequently be retrieved and included in the contextual metadata of the online meeting, for example.

In some embodiments, image/video processing module 214 may provide a summary of an image(s) shared during the online meeting. For example, image/video processing module 214 can analyze the content of an image using optical character recognition (OCR) to determine the locations (e.g., coordinate positions) of text within the image and extract the text from the image. Image/video processing module 214 can then apply a language model (e.g., a domain-specific language model) to the extracted text to generate a summary (e.g., text summary) of the image. Image/video processing module 214 can generate summaries of other images shared during the online meeting in a similar manner. In some embodiments, image/video processing module 214 can store the summaries of the images within content repository 206, where it can subsequently be retrieved and included in the contextual metadata of the online meeting, for example.

In some embodiments, image/video processing module 214 may convert the text contained in the images and/or the summaries to speech (e.g., audio format) using a suitable text to speech application. In some embodiments, image/video processing module 214 can store the audio file(s) containing the speech within content repository 206, where it can subsequently be retrieved and utilized.

Language translation module 216 is operable to translate the summarized content of the online meeting. For example, the summary content may be translated from a first language (e.g., language of the conversation which occurred during the online meeting) to a second or target language. The target language may be the language associated with a meeting participant. For example, a meeting participant may specify the target language. In other examples, the target language may be determined based on a geographic location of a meeting participant or participants. In such examples, the geographic location of a meeting participant may be determined from a user profile associated with the meeting participant. In any case, language translation module 216 can retrieve the stored content summary of the online meeting from content repository 206 and use NLP-based translators to translate the summarized content from its current language to one or more target languages. In another embodiment, language translation module 216 may translate the transcript of the online meeting from its current language to one or more target languages. In some embodiments, language translation module 216 can store the translated content (i.e., translated content summaries and translated transcripts) within content repository 206, where it can subsequently be retrieved and provided to attendees of the online meeting and/or others who could not attend the online meeting, for example. For example, a user located in China may be provided a Chinese language version of the content summary.

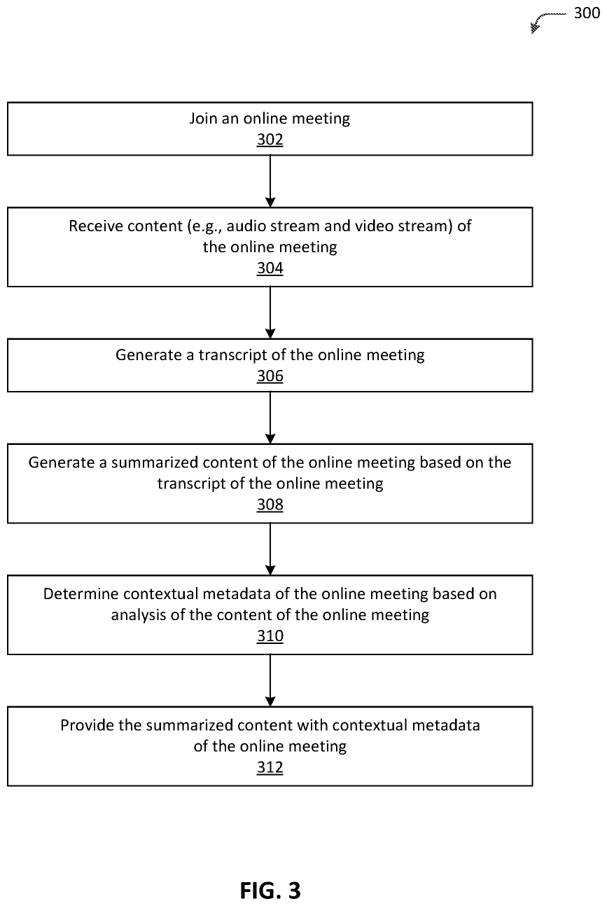

FIG. 3 is a flow diagram of an example process 300 for providing summarized content with contextual metadata of an online meeting, in accordance with an embodiment of the present disclosure. Process 300 may be implemented or performed by any suitable hardware, or combination of hardware and software, including without limitation the components of online meeting assistant service 106 of FIGS. 1 and 2. For example, in some embodiments, process 300 may be implemented within online meeting assistant service 106 an performed in response to enablement of a selectable virtual event assistant feature for an online meeting.

With reference to process 300, at 302, a virtual event assistant (e.g., virtual event assistant 202) can join the online meeting. For example, the virtual event assistant can join the online meeting using the meeting details provided in a meeting invite. In cases where the selectable virtual event assistant feature is enabled by a meeting participant during the meeting, the virtual event assistant can join the online meeting using meeting information/details from the client device used by the meeting participant to attend the online meeting. In any case, once joined, the virtual event assistant can participate in the online meeting.

At 304, the virtual meeting assistant can receive the content (e.g., audio stream and video stream) of the online meeting. For example, the content of the online meeting may be received in real-time from a meeting service which is hosting the online meeting. The virtual meeting assistant may store the received content on a non-volatile memory.

At 306, the virtual meeting assistant can generate a transcript of the online meeting. The virtual event assistant may process the audio stream of the online meeting to generate the transcript of the meeting. The transcript may include text strings which represent the conversation which occurred during the meeting.

At 308, the virtual meeting assistant can generate a summarized content online meeting. The summarized content of the online meeting may be based on the transcript of the online meeting. The summarized content provides a summary of the online meeting which accurately conveys the context and/or intent/topic of the meeting.

At 310, the virtual meeting assistant can determine contextual metadata of the online meeting. The virtual meeting assistant may analyze the content of the online meeting (e.g., transcript, audio stream, and/or video stream of the online meeting) using various techniques including AI and ML-based techniques to determine the contextual metadata.

At 312, the virtual meeting assistant can provide the summarized content with contextual metadata of the online meeting. For example, the summarized content and contextual metadata can be provided to attendees of the online meeting. The summarized content and contextual metadata may also be provided to others who were unable to attend the online meeting. In some cases, the summarized content and the contextual metadata may be in audio format (i.e., speech form). The recipients may then playback the summarized content and contextual metadata at their leisure to attain a comprehensive and enhanced review and understanding of the salient information of the online meeting.

FIG. 4 is a block diagram illustrating selective components of an example computing device 400 in which various aspects of the disclosure may be implemented, in accordance with an embodiment of the present disclosure. As shown, computing device 400 includes one or more processors 402, a volatile memory 404 (e.g., random access memory (RAM)), a non-volatile memory 406, a user interface (UI) 408, one or more communications interfaces 410, and a communications bus 412.

Non-volatile memory 406 may include: one or more hard disk drives (HDDs) or other magnetic or optical storage media; one or more solid state drives (SSDs), such as a flash drive or other solid-state storage media; one or more hybrid magnetic and solid-state drives; and/or one or more virtual storage volumes, such as a cloud storage, or a combination of such physical storage volumes and virtual storage volumes or arrays thereof.

User interface 408 may include a graphical user interface (GUI) 414 (e.g., a touchscreen, a display, etc.) and one or more input/output (I/O) devices 416 (e.g., a mouse, a keyboard, a microphone, one or more speakers, one or more cameras, one or more biometric scanners, one or more environmental sensors, and one or more accelerometers, etc.).

Non-volatile memory 406 stores an operating system 418, one or more applications 420, and data 422 such that, for example, computer instructions of operating system 418 and/or applications 420 are executed by processor(s) 402 out of volatile memory 404. In one example, computer instructions of operating system 418 and/or applications 420 are executed by processor(s) 402 out of volatile memory 404 to perform all or part of the processes described herein (e.g., processes illustrated and described in reference to FIGS. 1 through 3). In some embodiments, volatile memory 404 may include one or more types of RAM and/or a cache memory that may offer a faster response time than a main memory. Data may be entered using an input device of GUI 414 or received from I/O device(s) 416. Various elements of computing device 400 may communicate via communications bus 412.

The illustrated computing device 400 is shown merely as an illustrative client device or server and may be implemented by any computing or processing environment with any type of machine or set of machines that may have suitable hardware and/or software capable of operating as described herein.

Processor(s) 402 may be implemented by one or more programmable processors to execute one or more executable instructions, such as a computer program, to perform the functions of the system. As used herein, the term “processor” describes circuitry that performs a function, an operation, or a sequence of operations. The function, operation, or sequence of operations may be hard coded into the circuitry or soft coded by way of instructions held in a memory device and executed by the circuitry. A processor may perform the function, operation, or sequence of operations using digital values and/or using analog signals.

In some embodiments, the processor can be embodied in one or more application specific integrated circuits (ASICs), microprocessors, digital signal processors (DSPs), graphics processing units (GPUs), microcontrollers, field programmable gate arrays (FPGAs), programmable logic arrays (PLAs), multi-core processors, or general-purpose computers with associated memory.

Processor 402 may be analog, digital or mixed signal. In some embodiments, processor 402 may be one or more physical processors, or one or more virtual (e.g., remotely located or cloud computing environment) processors. A processor including multiple processor cores and/or multiple processors may provide functionality for parallel, simultaneous execution of instructions or for parallel, simultaneous execution of one instruction on more than one piece of data.

Communications interfaces 410 may include one or more interfaces to enable computing device 400 to access a computer network such as a Local Area Network (LAN), a Wide Area Network (WAN), a Personal Area Network (PAN), or the Internet through a variety of wired and/or wireless connections, including cellular connections.

In described embodiments, computing device 400 may execute an application on behalf of a user of a client device. For example, computing device 400 may execute one or more virtual machines managed by a hypervisor. Each virtual machine may provide an execution session within which applications execute on behalf of a user or a client device, such as a hosted desktop session. Computing device 400 may also execute a terminal services session to provide a hosted desktop environment. Computing device 400 may provide access to a remote computing environment including one or more applications, one or more desktop applications, and one or more desktop sessions in which one or more applications may execute.

In the foregoing detailed description, various features of embodiments are grouped together for the purpose of streamlining the disclosure. This method of disclosure is not to be interpreted as reflecting an intention that the claims require more features than are expressly recited. Rather, inventive aspects may lie in less than all features of each disclosed embodiment.

As will be further appreciated in light of this disclosure, with respect to the processes and methods disclosed herein, the functions performed in the processes and methods may be implemented in differing order. Additionally or alternatively, two or more operations may be performed at the same time or otherwise in an overlapping contemporaneous fashion. Furthermore, the outlined actions and operations are only provided as examples, and some of the actions and operations may be optional, combined into fewer actions and operations, or expanded into additional actions and operations without detracting from the essence of the disclosed embodiments.

Elements of different embodiments described herein may be combined to form other embodiments not specifically set forth above. Other embodiments not specifically described herein are also within the scope of the following claims.

Reference herein to “one embodiment” or “an embodiment” means that a particular feature, structure, or characteristic described in connection with the embodiment can be included in at least one embodiment of the claimed subject matter. The appearances of the phrase “in one embodiment” in various places in the specification are not necessarily all referring to the same embodiment, nor are separate or alternative embodiments necessarily mutually exclusive of other embodiments. The same applies to the term “implementation.”

As used in this application, the words “exemplary” and “illustrative” are used herein to mean serving as an example, instance, or illustration. Any aspect or design described herein as “exemplary” or “illustrative” is not necessarily to be construed as preferred or advantageous over other aspects or designs. Rather, use of the words “exemplary” and “illustrative” is intended to present concepts in a concrete fashion.

In the description of the various embodiments, reference is made to the accompanying drawings identified above and which form a part hereof, and in which is shown by way of illustration various embodiments in which aspects of the concepts described herein may be practiced. It is to be understood that other embodiments may be utilized, and structural and functional modifications may be made without departing from the scope of the concepts described herein. It should thus be understood that various aspects of the concepts described herein may be implemented in embodiments other than those specifically described herein. It should also be appreciated that the concepts described herein are capable of being practiced or being carried out in ways which are different than those specifically described herein.

Terms used in the present disclosure and in the appended claims (e.g., bodies of the appended claims) are generally intended as “open” terms (e.g., the term “including” should be interpreted as “including, but not limited to,” the term “having” should be interpreted as “having at least,” the term “includes” should be interpreted as “includes, but is not limited to,” etc.).

Additionally, if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to embodiments containing only one such recitation, even when the same claim includes the introductory phrases “one or more” or “at least one” and indefinite articles such as “a” or “an” (e.g., “a” and/or “an” should be interpreted to mean “at least one” or “one or more”); the same holds true for the use of definite articles used to introduce claim recitations.

In addition, even if a specific number of an introduced claim recitation is explicitly recited, such recitation should be interpreted to mean at least the recited number (e.g., the bare recitation of “two widgets,” without other modifiers, means at least two widgets, or two or more widgets). Furthermore, in those instances where a convention analogous to “at least one of A, B, and C, etc.” or “one or more of A, B, and C, etc.” is used, in general such a construction is intended to include A alone, B alone, C alone, A and B together, A and C together, B and C together, or A, B, and C together, etc.

All examples and conditional language recited in the present disclosure are intended for pedagogical examples to aid the reader in understanding the present disclosure, and are to be construed as being without limitation to such specifically recited examples and conditions. Although illustrative embodiments of the present disclosure have been described in detail, various changes, substitutions, and alterations could be made hereto without departing from the scope of the present disclosure. Accordingly, it is intended that the scope of the present disclosure be limited not by this detailed description, but rather by the claims appended hereto.

1. A method comprising:
joining, by a virtual event assistant, an online meeting;
receiving, by the virtual event assistant, a content of the online meeting in real-time, the content including an audio stream and a video stream of the online meeting;
generating, by the virtual event assistant, a summarized content of the online meeting based on a transcript of the online meeting, wherein generating the summarized content includes applying one or more artificial intelligence (AI)-based techniques to the transcript of the online meeting;
determining, by the virtual event assistant, contextual metadata of the online meeting based on analysis of the content of the online meeting, wherein the analysis of the content includes applying a domain-specific language model to text within an image shared during the online meeting to generate a summary of the image; and
providing, by the virtual event assistant, the summarized content with the contextual metadata of the online meeting.

2. The method of claim 1, wherein generating the summarized content includes applying a domain-specific language model to the transcript of the online meeting.

3. The method of claim 2, wherein the domain-specific language model is tuned to a domain-specific vocabulary representing language used within an organization.

4. The method of claim 1, wherein the analysis of the content of the online meeting includes using AI and machine learning (ML)-based techniques.

5. The method of claim 1, wherein the contextual metadata includes information indicative of participants who participated in the online meeting.

6. The method of claim 1, wherein the contextual metadata includes information indicative of active participants in the online meeting.

7. The method of claim 1, wherein the contextual metadata includes information indicative of a topic of the online meeting.

8. The method of claim 1, wherein the contextual metadata includes information indicative of an intent of the online meeting.

9. The method of claim 1, wherein the contextual metadata includes information indicative of a sentiment associated with a participant in the online meeting.

10. (canceled)

11. (canceled)

12. The method of claim 1, wherein the contextual metadata includes information indicative of a question raised and answered during the online meeting.

13. A system comprising:
one or more non-transitory machine-readable mediums configured to store instructions; and
one or more processors configured to execute the instructions stored on the one or more non-transitory machine-readable mediums, wherein execution of the instructions causes the one or more processors to carry out a process comprising:
responsive to joining an online meeting, receiving a content of the online meeting in real-time, the content including an audio stream and a video stream of the online meeting;
generating a summarized content of the online meeting based on a transcript of the online meeting, wherein generating the summarized content includes applying one or more artificial intelligence (AI)-based techniques to the transcript of the online meeting;
determining contextual metadata of the online meeting based on analysis of the content of the online meeting, wherein the analysis of the content includes applying a domain-specific language model to text within an image shared during the online meeting to generate a summary of the image; and
providing the summarized content with the contextual metadata of the online meeting.

14. The system of claim 13, wherein generating the summarized content includes applying a domain-specific language model to the transcript of the online meeting, the domain-specific language model being tuned to a domain-specific vocabulary representing language used within an organization.

15. The system of claim 13, wherein the analysis of the content of the online meeting includes using AI and machine learning (ML)-based techniques.

16. The system of claim 13, wherein the contextual metadata includes information indicative of participants who participated in the online meeting.

17. The system of claim 13, wherein the contextual metadata includes information indicative of active participants in the online meeting.

18. The system of claim 13, wherein the contextual metadata includes information indicative of one of a topic of the online meeting, an intent of the online meeting, a sentiment associated with a participant in the online meeting, or a question raised and answered during the online meeting.

19. (canceled)

20. A non-transitory machine-readable medium encoding instructions that when executed by one or more processors cause a process to be carried out, the process comprising:
responsive to joining an online meeting, receiving a content of the online meeting in real-time, the content including an audio stream and a video stream of the online meeting;
generating a summarized content of the online meeting based on a transcript of the online meeting, wherein generating the summarized content includes applying one or more artificial intelligence (AI)-based techniques to the transcript of the online meeting;
determining contextual metadata of the online meeting based on analysis of the content of the online meeting, wherein the analysis of the content includes applying a domain-specific language model to text within an image shared during the online meeting to generate a summary of the image; and
providing the summarized content with the contextual metadata of the online meeting.
